(19) United States
(12) Patent Application Publication
(10) Pub. No.: US 2018/0236474 A1
(43) Pub. Date: Aug. 23, 2018

(54) Makeup Device and Makeup Jet Device Thereof

(71) Applicant: Glory Makeup Inc., Taipei City (TW)

(72) Inventor: Chuan-Wei Wang, Taoyuan City (TW)

(21) Appl. No.: 15/437,075

(22) Filed: Feb. 20, 2017

(51) Int. Cl. B05B 12/12; B05B 1/18; A45D 40/26; A45D 34/04; A45D 33/00; A45D 44/00; B05B 13/04

(52) U.S. Cl. CPC B05B 12/122; B05B 1/185; A45D 40/26; A45D 2044/007; A45D 33/00; A45D 44/005; B05B 13/0421; A45D 34/04

(57) ABSTRACT

A makeup device and a makeup jet device thereof are disclosed. The makeup device includes a platform, at least one rotating board, at least one rotating axle, at least one gear, a driving source, at least one substrate, at least one actuated jet head and a controller combined with each other. The actuated jet head includes first nozzle sets, second nozzle sets, first passages accommodating color cosmetic materials and second passages accommodating at least one of a moisturizer and a foundation. The first nozzle sets respectively connect with the first passages, and the second nozzle sets respectively connect with the second passages. The first nozzle sets and the second nozzle sets are arranged toward skin of a body part of a user, wherein the nozzle size of the first nozzle set is less than that of the second nozzle set.

### BACKGROUND OF THE INVENTION

### Field of the Invention

The present invention relates to a makeup technology, particularly to a makeup device and a makeup jet device thereof.

### Description of the Related Art

People have a nature of enjoying pretty things. Accordingly, many large companies have developed various care and makeup products for consumers to purchase. However, repeated practice is required in order to improve makeup skills and have makeup-applied faces that are satisfactory and suited to the consumers themselves. In addition, various cosmetics and tools are purchased for different blackened eyebrows, eye shadows, eyelashes, eye liners, facial makeup, lip makeup, facial sculpting, and color changes. In this case, with different makeup capabilities and applied products, the makeup effects between the actual and desired appearances are different for each consumer.

As various information technologies have been developed, typical color simulation devices are designed for a trial of makeup or care products on screen before a user buys and applies the products, thereby replacing the in-situ application of the products. For example, in US 2005/0135675 A1, a simulation method for a makeup trial and the device thereof are disclosed. Deep image sensors are utilized to establish a three-dimensional (3D) image according to a target image and a profile signal of a user, such as the lips, eyes, or the entire face. Then, makeup data for makeup products are provided such that the user can select a corresponding makeup product using a touch panel for emulating a color makeup of the target image and displaying a makeup post-application image on a display module. Such a way requires manual skills for applying facial makeup, and hence the actual makeup may not have the same effect as the simulated one displayed on screen. Besides, in U.S. Pat. No. 8,464,732 B2, FIGS. 4-7 show a piezoelectric nozzle, a brush with a tip, a jet nozzle, or a pressure nozzle in a rotor. However, the US patent uses a single cosmetic tool to provide cosmetic material for different parts of a human face, whereby the makeup speed is very slow.

To overcome the abovementioned problems, the present invention provides a makeup device and a makeup jet device thereof, so as to solve the afore-mentioned problems of the prior art.

### SUMMARY OF THE INVENTION

A primary objective of the present invention is to provide a makeup device and a makeup jet device thereof, which uses an actuated jet head with nozzles of different sizes to automatically eject color cosmetic materials and at least one of a moisturizer and a foundation to a skin, thereby rapidly applying makeup to the skin and reducing the purchase cost on various cosmetics and associated tools.

Another objective of the present invention is to provide a makeup device and a makeup jet device thereof, which uses an actuated jet head to replace a robot arm of a conventional technology and rotates the actuated jet head toward the skin, so as to achieve friendly makeup application.

To achieve the abovementioned objectives, the present invention provides a makeup device, which comprises a platform, at least one rotating board, at least one rotating axle, at least one gear, a driving source, at least one substrate, at least one actuated jet head, a controller, at least one distance sensor, at least one image sensor, a computer, a plurality of first cosmetics suppliers and at least one second cosmetics supply. The rotating board is arranged on the platform. The rotating axle penetrates through the platform and the rotating board and is fixed to the rotating board. The gear is connected with the rotating axle. The driving source is combined with the gear. The substrate is vertically connected with the rotating board, and at least one installation surface of at least one substrate is arranged toward skin of a body part of a user, such as facial skin. The actuated jet head is arranged on the installation surface, and an outer surface of the actuated jet head is arranged toward the facial skin. The actuated jet head comprises a plurality of first nozzle sets, a plurality of second nozzle sets, a plurality of first passages and a plurality of second passages. The first nozzle sets and the second nozzle sets are formed on the outer surface, and each first nozzle set comprises a plurality of first nozzles arranged in columns, and each second nozzle set comprises a plurality of second nozzles arranged in columns, and a diameter of the first nozzle is less than that of the second nozzle. The first passages and the second passages are connected to an exterior. The first passages respectively correspond to the first nozzle sets, and the first nozzles of the identical first nozzle set connect to each other through the identical first passage. The second passages respectively correspond to the second nozzle sets, and the second nozzles of the identical second nozzle set connect to each other through the identical second passage. The first passages accommodate color cosmetic materials, and the second passages accommodate at least one of a moisturizer and a foundation. The controller is electrically connected with the actuated jet head and the driving source, uses the driving source and the gear to rotate the rotating board, the substrate and the actuated jet head with the rotating axle being an axis, actuates the actuated jet head to eject at least one of the moisturizer and the foundation from the second nozzle to the facial skin, and then actuates the actuated jet head to eject the color cosmetic material from the first nozzle to the facial skin.

The distance sensor is arranged on the installation surface and electrically connected with the controller. When the distance sensor detects that a distance between the distance sensor and the facial skin reaches a given value, the distance sensor generates a sensing signal, and the controller receives the sensing signal to actuate the actuated jet head and the driving source. The image sensor is arranged on the installation surface and electrically connected with the controller. When the image sensor retrieves an image of the facial skin, the image sensor transmits the image to the controller, and the controller actuates the actuated jet head and the driving source according to skin color, a forehead, eyes, a lip, a nose, and cheeks of the facial skin.

The computer is electrically connected with the controller and stores given facial models. The computer chooses one of the facial models and transmits it to the controller, and the controller actuates the actuated jet head and the driving source according to the chosen facial model.

The first cosmetics suppliers are respectively connected with the first passages. The first cosmetics suppliers store the color cosmetic materials and supply the first passages with the color cosmetic materials. The second cosmetics supply is connected with the second passages. The second cosmetics supply stores at least one of the moisturizer and the foundation and supplies the second passages with at least one of the moisturizer and the foundation.

The present invention also provides a makeup jet device, which comprises an actuated jet head, a controller, a plurality of first cosmetics suppliers and at least one second cosmetics supply. The actuated jet head has an outer surface. The actuated jet head comprises a plurality of first nozzle sets, a plurality of second nozzle sets, a plurality of first passages and a plurality of second passages. The first nozzle sets and the second nozzle sets are formed on the outer surface, and each first nozzle set comprises a plurality of first nozzles arranged in columns, and each second nozzle set comprises a plurality of second nozzles arranged in columns, and a diameter of the first nozzle is less than that of the second nozzle. The first passages and the second passages are formed in an interior of the actuated jet head and connected to an exterior. The first passages respectively correspond to the first nozzle sets, and the first nozzles of the identical first nozzle set connect to each other through the identical first passage. The second passages respectively correspond to the second nozzle sets, and the second nozzles of the identical second nozzle set connect to each other through the identical second passage. The first passages accommodate color cosmetic materials, and the second passages accommodate at least one of a moisturizer and a foundation. The controller is electrically connected with the actuated jet head, actuates the actuated jet head to eject at least one of the moisturizer and the foundation from the second nozzle, and then actuates the actuated jet head to eject the color cosmetic material from the first nozzle.

The first cosmetics suppliers are respectively connected with the first passages. The first cosmetics suppliers store the color cosmetic materials and supply the first passages with the color cosmetic materials. The second cosmetics supply is connected with the second passages. The second cosmetics supply stores at least one of the moisturizer and the foundation and supplies the second passages with at least one of the moisturizer and the foundation.

Below, the embodiments are described in detail in cooperation with the drawings to make easily understood the technical contents, characteristics and accomplishments of the present invention.

### BRIEF DESCRIPTION OF THE DRAWINGS

FIG. 1 is a perspective view of a makeup device according to an embodiment of the present invention;

FIG. 2 is a block diagram schematically showing the makeup device according to an embodiment of the present invention;

FIG. 3 is a perspective view of an actuated jet head according to an embodiment of the present invention;

FIG. 4 is a sectional view of the actuated jet head taken along Line A-A′ of FIG. 3;

FIG. 5 is a sectional view of the actuated jet head taken along Line B-B′ of FIG. 3;

FIG. 6 is a diagram schematically showing the first nozzles and the second nozzles clustering together according to an embodiment of the present invention;

FIG. 7 is a diagram schematically showing the first nozzles and the second nozzles arranged in an alternate way according to an embodiment of the present invention;

FIG. 8 is a diagram schematically showing a user using the makeup device when the actuated jet head is rotated according to an embodiment of the present invention; and

FIG. 9 is a diagram schematically showing a user using the makeup device when the actuated jet head is fixed according to an embodiment of the present invention.

### DETAILED DESCRIPTION OF THE INVENTION

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

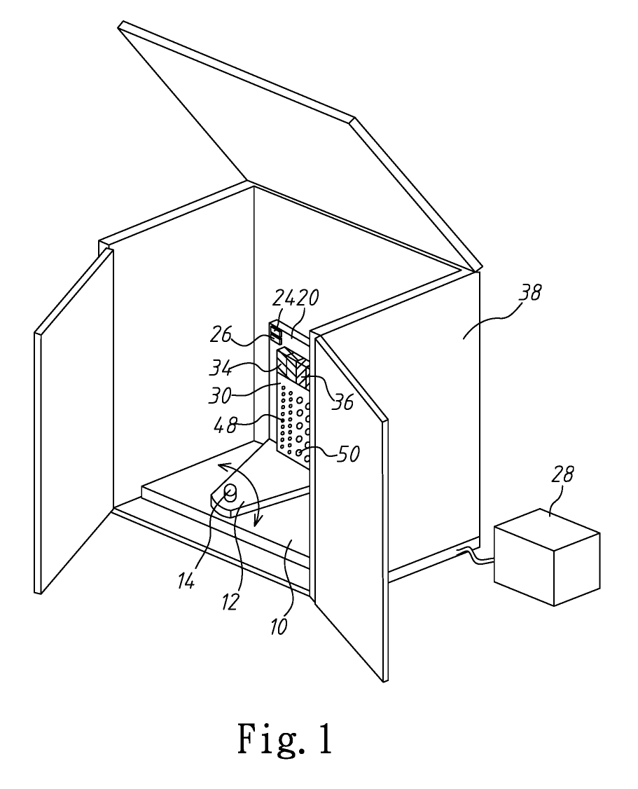

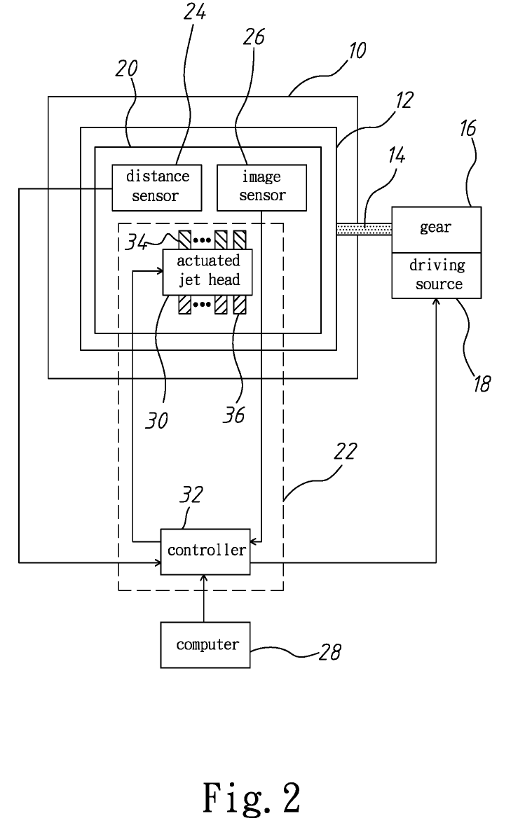

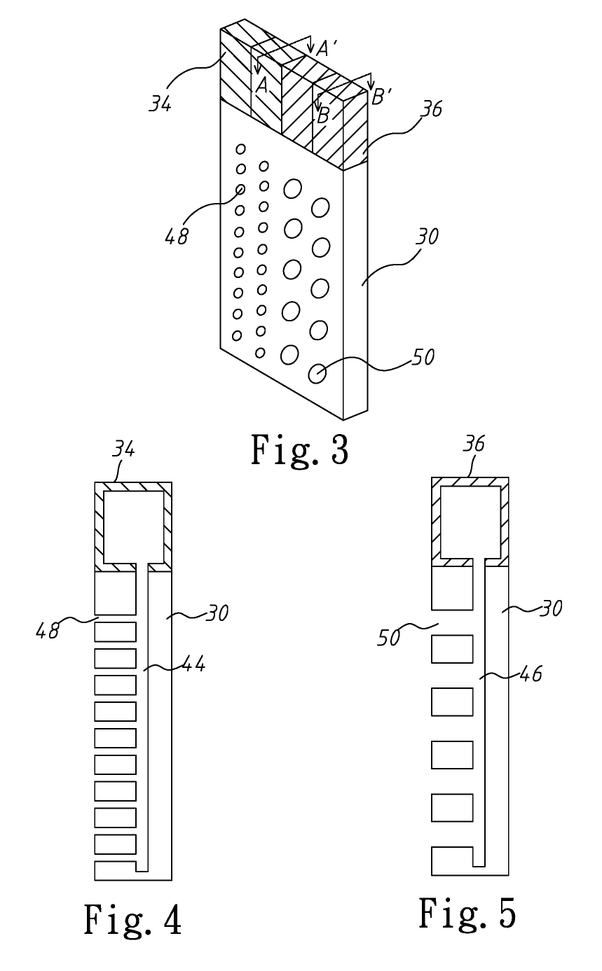

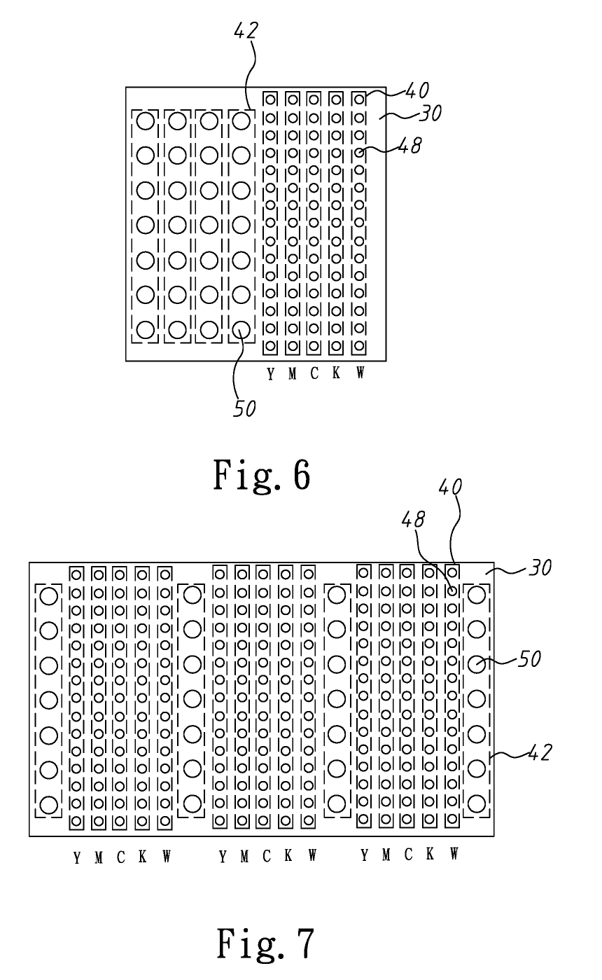

Refer to FIG. 1, FIG. 2, FIG. 3, FIG. 4, FIG. 5, FIG. 6 and FIG. 7 to introduce a makeup device of the present invention. The makeup device of the present invention comprises a platform 10, at least one rotating board 12, at least one rotating axle 14, at least one gear 16, a driving source 18, at least one substrate 20, a makeup jet device 22, at least one distance sensor 24, at least one image sensor 26, and a computer 28, wherein the makeup jet device 22 further comprises at least one actuated jet head 30, a controller 32, a plurality of first cosmetics suppliers 34 and at least one second cosmetics supply 36, and the driving source 18 is exemplified by an electric motor. The present invention applies a box 38 with a bottom thereof used as the platform 10. For example, the box 38 has a width of 21 cm, a length of 30 cm and a height of 12 cm. The rotating board 12, the rotating axle 14, the gear 16, the driving source 18, the substrate 20, the makeup jet device 22, the distance sensor 24, and the image sensor 26 are all installed on the box 38 to achieve minimization, whereby the makeup device is portable. In the embodiment, the amounts of the rotating board 12, the rotating axle 14, the gear 16, the substrate 20, the distance sensor 24, the image sensor 26 and the actuated jet head 30 are respectively one, one, one, one, one, one and one. Besides, there are the plurality of first cosmetics suppliers 32 and the plurality of second cosmetics supply 34. The rotating board 12 is arranged on the platform 10. The rotating axle 14 penetrates through the platform 10 and the rotating board 12 and is fixed to the rotating board 12. The gear 16 is connected with the rotating axle 14. The driving source 18 is combined with the gear 16. The substrate 20 is vertically connected with the rotating board 12, and an installation surface of the substrate 20 is arranged toward skin of a body part of a user, such as facial skin. The actuated jet head 30 is arranged on the installation surface of the substrate 20, and an outer surface of the actuated jet head 30 is arranged toward the facial skin.

The actuated jet head 30 comprises a plurality of first nozzle sets 40, a plurality of second nozzle sets 42, a plurality of first passages 44 and a plurality of second passages 46. The first nozzle sets 40 and the second nozzle sets 42 are formed on the outer surface of the actuated jet head 30. The first nozzle sets 40 cluster together and the second nozzle sets 42 cluster together, as shown in FIG. 6. Alternatively, the first nozzle sets 40 and the second nozzle sets 42 are alternately arranged, as shown in FIG. 7. Each first nozzle set 40 comprises a plurality of first nozzles 48 arranged in columns, and each second nozzle set 42 comprises a plurality of second nozzles 50 arranged in columns, and a diameter of the first nozzle 48 is less than that of the second nozzle 50. The diameter of the second nozzle 50 is two times the diameter of the first nozzle 48. For example, the diameters of the second nozzle 50 and the first nozzle 48 are respectively 50 um and 25 um. The first nozzles 48 of the identical first nozzle set 40 and the second nozzles 50 of the identical second nozzle set 42 are arranged in the axis direction of the rotating axle 14, wherein the axis direction is perpendicular to a direction that two eyes of the facial skin are located.

The first passages 44 and the second passages 46 are connected to an exterior. The first passages 44 respectively correspond to the first nozzle sets 40, and the first nozzles 48 of the identical first nozzle set 40 connect to each other through the identical first passage 44. The second passages 46 respectively correspond to the second nozzle sets 42, and the second nozzles 50 of the identical second nozzle set 42 connect to each other through the identical second passage 46. The first passages 44 accommodate color cosmetic materials, and the second passages 46 accommodate at least one of a moisturizer and a foundation. That is to say, the second passages 46 accommodate the moisturizer, the foundation or both. This is because color cosmetic materials are used to apply to a small area of the facial skin, and the moisturizer and the foundation are used to apply to a large area of the facial skin. For example, the color cosmetic material is a powder material, a foam material, a gel material, a liquid material, or a solid cosmetic material, and the color cosmetic material is a concealer material, an eyebrow material, a cheek material, a lip material, or a corrector material, and the foundation is a powder material or a liquid material, and the moisturizer is a liquid material.

The controller 32 is electrically connected with the actuated jet head 30 and the driving source 18, uses the driving source 18 and the gear 16 to rotate the rotating board 12, the substrate 20 and the actuated jet head 30 with the rotating axle 14 being an axis, actuates the actuated jet head 30 to eject at least one of the moisturizer and the foundation from the second nozzle 50 to the facial skin, and then actuates the actuated jet head 30 to eject the color cosmetic material from the first nozzle 48 to the facial skin. In a conventional technology, a robot arm actively moves toward a human face to perform makeup application. Distinct from the conventional technology, the present invention rotates the actuated jet head 30 with an axis corresponding to the facial skin instead of actively moving toward the facial skin, thereby achieving friendly makeup application. For instance, the actuated jet head 30 is of a piezoelectric type or a thermospray type. When the actuated jet head 30 is a piezoelectric jet head, the piezoelectric jet head has multiple piezoelectric films respectively corresponding to the first passages 44 and the second passages 46. The controller 32 can drive the piezoelectric films to vibrate, so as to eject at least one of the moisturizer and the foundation from the second nozzle 50 and eject the color cosmetic material from the first nozzle 48. When the actuated jet head 30 is a thermospray jet head, the thermospray jet head has multiple heaters respectively corresponding to the first passages 44 and the second passages 46. If the color cosmetic material, the moisturizer and the foundation are not solid materials, the controller 32 can drive the heaters to heat them to form thermal bubbles ejected from the second nozzle 50 and the first nozzle 48.

The distance sensor 24 is arranged on the installation surface of the substrate 20 and electrically connected with the controller 32. When the distance sensor 24 detects that a distance between the distance sensor 24 and the facial skin reaches a given value such as 5 cm, the distance sensor 24 generates a sensing signal. The controller 32 receives the sensing signal to actuate the actuated jet head 30 and the driving source 18. For example, the distance sensor 24 is realized with an infrared sensor or an ultrasound sensor.

The image sensor 26 is arranged on the installation surface of the substrate 20 and electrically connected with the controller 32. When the image sensor 26 retrieves an image of the facial skin, the image sensor 26 transmits the image to the controller 32, and the controller 32 actuates the actuated jet head 30 and the driving source 18 according to skin color, a forehead, eyes, a lip, a nose, and cheeks of the facial skin. The image sensor 26 can be a charge coupled device (CCD), a complementary metal oxide semiconductor (CMOS) device, or an equivalent device, but those are preferably cooperated with a color video camera so as to automatize makeup application. The image sensor 26 can feed back a signal to the controller 32 in order to adjust the makeup application position.

The computer 28 is electrically connected with the controller 32 and stores given facial models. The computer 28 chooses one of the facial models and transmits it to the controller 32, and the controller 32 actuates the actuated jet head 30 and the driving source 18 according to the chosen facial model. The computer 28 can be a notebook, a PC, a tablet PC, a netbook, a mobile phone, a personal digital assistant (PDA), and/or an equivalent. The computer 28 includes a processor and a storage device, such as a hard disk drive, compact disk drive, SD reader, MMS reader, or a built-in flash memory. The abovementioned facial models can be pre-taken and pre-stored in the storage device, or stored in a network drive for an internet download. The facial models include the specific facial images of a user, makeup templates of other users and Chinese or Western opera masks. As a result, in addition to a typical facial makeup, the present invention can be used to make facial masks in an opera performance, and apply to the cultural and creative industry, such as theater and drama.

The first cosmetics suppliers 34 are respectively connected with the first passages 44. The first cosmetics suppliers 34 store the color cosmetic materials and supply the first passages 44 with the color cosmetic materials. The second cosmetics supplies 36 are connected with the second passages 46. The second cosmetics supplies 36 stores at least one of the moisturizer and the foundation and supply the second passages 46 with at least one of the moisturizer and the foundation. The first cosmetics suppliers 34 and the second cosmetics supplies 36 can reduce the purchase cost on various cosmetics and associated tools. The color cosmetic material stored in each first cosmetics supply 34 has single color. For example, the color of the color cosmetic materials stored in the first cosmetics supplies 36 comprises cyan (C), yellow (Y), magenta (M), black (K) and white (W). The first nozzles 48 can jet a single color material or color materials, cyan (C), yellow (Y), magenta (M), black (K) and white (W) to be mixed into various colors or produce a gradient color effect. Thus, the color richness of the cosmetic materials is increased. For example, the first cosmetics suppliers 34 and the second cosmetics supplies 36 can be realized with receptacles or cartridges. The first cosmetics suppliers 34 and the second cosmetics supplies 36 are arranged on a top of the actuated jet head 30. Besides, the top of the actuated jet head 30 has inlets of the first passages 44 and the second passages 46. Each first cosmetics supply 34 and each second cosmetics supply 36 have internal spaces and outlets thereof in communication with the inlets of the first passages 44 and the second passages 46.

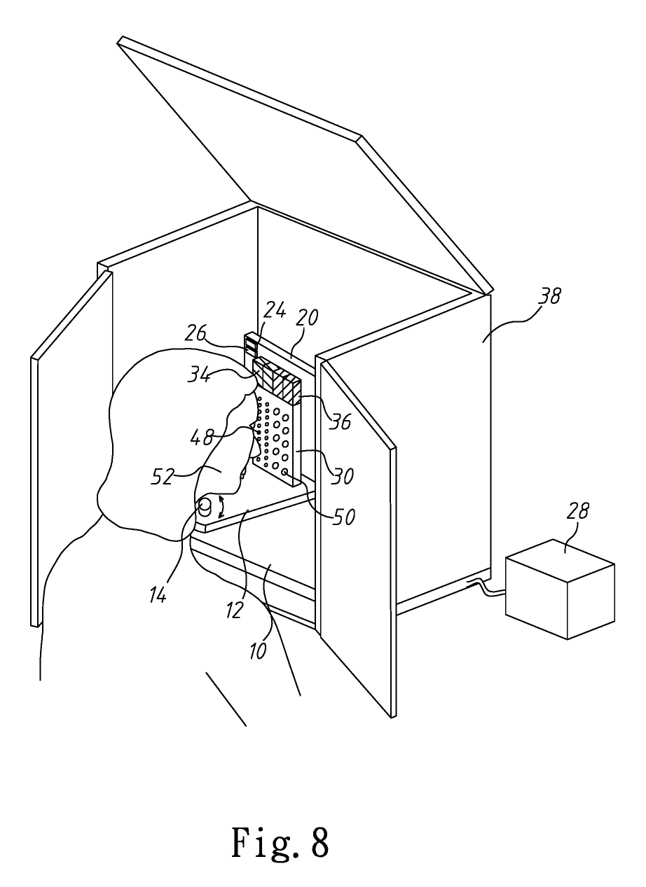

The operation of the makeup device of the present invention is introduced as below. Refer to FIG. 2 and FIG. 8. Firstly, a user uses the computer 28 to select a facial model and transmits it to the controller 32, and moves to a position in front of the actuated jet head 30, whereby the first nozzle sets 40 and the second nozzle sets 42 are arranged toward facial skin 52 of the user. When the distance sensor 24 detects that a distance between the facial skin 52 and the distance sensor 24 reaches the give value, the distance sensor 24 generates a sensing signal. The controller 32 receives the sensing signal to actuate the actuated jet head 30 and the driving source 18. According to the selected facial model, the controller 32 uses the driving source 18 and the gear 16 to rotate the rotating board 12, the substrate 20 and the actuated jet head 30 with the rotating axle 14 being an axis, automatically actuates the actuated jet head 30 to eject at least one of the moisturizer and the foundation from the second nozzle 50 to the facial skin 52, and then automatically actuates the actuated jet head 30 to eject the color cosmetic material from the first nozzle 48 to the facial skin 52, thereby rapidly applying makeup to the facial skin 52. Simultaneously, the image sensor 26 retrieves an image of the facial skin 52, the image sensor 26 transmits the image to the controller 32, and the controller 32 actuates the actuated jet head 30 and the driving source 18 according to skin color, a forehead, eyes, a lip, a nose, and cheeks of the facial skin 52.

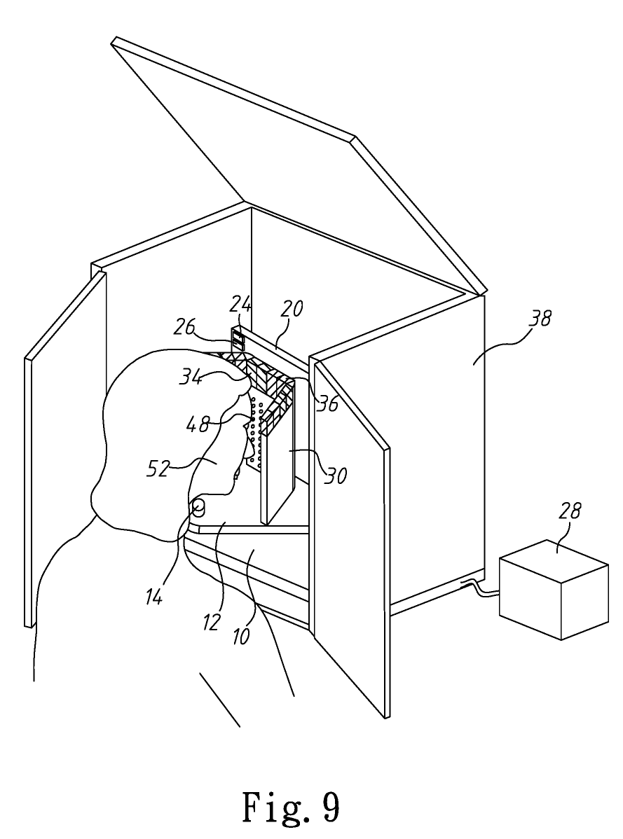

In addition, the actuated jet head 30 is alternatively fixed and the other operation is the same to the abovementioned embodiment so will not be reiterated, as shown in FIG. 9. Or otherwise, the amounts of the rotating board 12, the rotating axle 14, the gear 16, the substrate 20, the distance sensor 24, the image sensor 26 and the actuated jet head 30 are respectively two, two, two, two, two, two and two. As shown in FIG. 2, the rotating axles 14 respectively penetrate through the rotating boards 12 and connect with the gear 16. The substrates 20 are respectively vertically connected with the rotating boards 12. The actuated jet heads 30 are respectively arranged on the substrates 20. The distance sensors 24 are respectively arranged on the actuated jet heads 30, and the image sensors 26 are respectively arranged on the actuated jet heads 30. In such a case, the speed of makeup application is greatly improved.

In conclusion, the present invention can really improve the inconvenient manual makeup application by automatically applying makeup to the skin, reduce the purchase cost on various cosmetics and associated tools, and variously embody a face with makeup which the user selects in the computer. In addition, the makeup device of the present invention can be miniaturized as a portable device.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

1. A makeup device comprising:
a platform;
at least one rotating board arranged on said platform;
at least one rotating axle penetrating through said platform and said at least one rotating board and fixed to said at least one rotating board;
at least one gear connected with said at least one rotating axle;
a driving source combined with said at least one gear;
at least one substrate vertically connected with said at least one rotating board, and at least one installation surface of said at least one substrate is arranged toward skin of a body part of a user;
at least one actuated jet head arranged on said at least one installation surface, and an outer surface of said at least one actuated jet head is arranged toward said skin, and said at least one actuated jet head accommodates color cosmetic materials and at least one of a moisturizer and a foundation; and
a controller electrically connected with said at least one actuated jet head and said driving source, using said driving source and said at least one gear to rotate said at least one rotating board, said at least one substrate and said at least one actuated jet head with said at least one rotating axle being an axis, actuating said at least one actuated jet head to eject at least one of said moisturizer and said foundation to said skin, and then actuating said at least one actuated jet head to eject said color cosmetic material to said skin.

2. The makeup device according to claim 1, wherein said skin is a facial skin.

3. The makeup device according to claim 2, wherein said at least one actuated jet head further comprises:
a plurality of first nozzle sets and a plurality of second nozzle sets formed on said outer surface, and each said first nozzle set comprises a plurality of first nozzles arranged in columns, and each said second nozzle set comprises a plurality of second nozzles arranged in columns, and a diameter of said first nozzle is less than that of said second nozzle; and
a plurality of first passages and a plurality of second passages connected to an exterior, and said first passages respectively correspond to said first nozzle sets, and said first nozzles of identical said first nozzle set connect to each other through identical said first passage, and said second passages respectively correspond to said second nozzle sets, and said second nozzles of identical said second nozzle set connect to each other through identical said second passage, and said first passages accommodate said color cosmetic materials, and said second passages accommodate at least one of said moisturizer and said foundation, and said controller actuates said at least one actuated jet head to eject at least one of said moisturizer and said foundation from said second nozzle to said skin, and then actuates said at least one actuated jet head to eject said color cosmetic material from said first nozzle to said skin.

4. The makeup device according to claim 3, further comprising at least one distance sensor arranged on said installation surface and electrically connected with said controller, and when said at least one distance sensor detects that a distance between said at least one distance sensor and said skin reaches a given value, said at least one distance sensor generates a sensing signal, and said controller receives said sensing signal to actuate said at least one actuated jet head and said driving source.

5. The makeup device according to claim 3, further comprising at least one image sensor arranged on said installation surface and electrically connected with said controller, and when said at least one image sensor retrieves an image of said skin, said at least one image sensor transmits said image to said controller, and said controller actuates said at least one actuated jet head and said driving source according to skin color, a forehead, eyes, a lip, a nose, and cheeks of said skin.

6. The makeup device according to claim 3, wherein said driving source is an electric motor.

7. The makeup device according to claim 3, further comprising a computer electrically connected with said controller and storing given facial models, and said computer chooses one of said facial models and transmits it to said controller, and said controller actuates said at least one actuated jet head and said driving source according to chosen said facial model.

8. The makeup device according to claim 3, further comprising:
a plurality of first cosmetics suppliers respectively connected with said first passages, storing said color cosmetic materials and supplying said first passages with said color cosmetic materials; and
at least one second cosmetics supply connected with said second passages, storing at least one of said moisturizer and said foundation and supplying said second passages with at least one of said moisturizer and said foundation.

9. The makeup device according to claim 8, wherein said color cosmetic material stored in each said first cosmetics supply has single color.

10. The makeup device according to claim 9, wherein color of said color cosmetic materials stored in said first cosmetics supplies comprises cyan, yellow, magenta, black and white.

11. The makeup device according to claim 3, wherein said first nozzle sets cluster together and said second nozzle sets cluster together.

12. The makeup device according to claim 3, wherein said first nozzle sets and said second nozzle sets are alternately arranged.

13. The makeup device according to claim 3, wherein said at least one actuated jet head is of a piezoelectric type or a thermospray type.

14. The makeup device according to claim 3, wherein said foundation is a powder material or a liquid material, and said moisturizer is a liquid material.

15. The makeup device according to claim 3, wherein said color cosmetic material is a powder material, a foam material, a gel material, a liquid material, or a solid cosmetic material, and said color cosmetic material is a concealer material, an eyebrow material, a cheek material, a lip material, or a corrector material.

16. The makeup device according to claim 3, wherein said diameter of said second nozzle is two times said diameter of said first nozzle.

17. A makeup jet device comprising:
an actuated jet head having an outer surface, and said actuated jet head comprises:
a plurality of first nozzle sets and a plurality of second nozzle sets formed on said outer surface, and each said first nozzle set comprises a plurality of first nozzles arranged in columns, and each said second nozzle set comprises a plurality of second nozzles arranged in columns, and a diameter of said first nozzle is less than that of said second nozzle; and
a plurality of first passages and a plurality of second passages formed in an interior of said actuated jet head and connected to an exterior, and said first passages respectively correspond to said first nozzle sets, and said first nozzles of identical said first nozzle set connect to each other through identical said first passage, and said second passages respectively correspond to said second nozzle sets, and said second nozzles of identical said second nozzle set connect to each other through identical said second passage, and said first passages accommodate color cosmetic materials, and said second passages accommodate at least one of a moisturizer and a foundation; and
a controller electrically connected with said actuated jet head, actuating said actuated jet head to eject at least one of said moisturizer and said foundation from said second nozzle, and then actuating said actuated jet head to eject said color cosmetic material from said first nozzle.

18. The makeup jet device according to claim 17, further comprising:
a plurality of first cosmetics suppliers respectively connected with said first passages, storing said color cosmetic materials and supplying said first passages with said color cosmetic materials; and
at least one second cosmetics supply connected with said second passages, storing at least one of said moisturizer and said foundation and supplying said second passages with at least one of said moisturizer and said foundation.

19. The makeup jet device according to claim 18, wherein said color cosmetic material stored in each said first cosmetics supply has single color.

20. The makeup jet device according to claim 19, wherein color of said color cosmetic materials stored in said first cosmetics supplies comprises cyan, yellow, magenta, black and white.

21. The makeup jet device according to claim 17, wherein said first nozzle sets cluster together and said second nozzle sets cluster together.

22. The makeup jet device according to claim 17, wherein said first nozzle sets and said second nozzle sets are alternately arranged.

23. The makeup jet device according to claim 17, wherein said actuated jet head is of a piezoelectric type or a thermospray type.

24. The makeup jet device according to claim 17, wherein said foundation is a powder material or a liquid material, and said moisturizer is a liquid material.

25. The makeup jet device according to claim 17, wherein said color cosmetic material is a powder material, a foam material, a gel material, a liquid material, or a solid cosmetic material, and said color cosmetic material is a concealer material, an eyebrow material, a cheek material, a lip material, or a corrector material.

26. The makeup jet device according to claim 17, wherein said diameter of said second nozzle is two times said diameter of said first nozzle.
